(19) United States
(12) Patent Application Publication
(10) Pub. No.: US 2025/0205854 A1
(43) Pub. Date: Jun. 26, 2025

(54) CAVITY MOLD-REPLACING STRUCTURE OF A PARALLEL CRIMPING PLIER

(71) Applicant: WEI-CHE LEE, Changhua County (TW)

(72) Inventor: WEI-CHE LEE, Changhua County (TW)

(21) Appl. No.: 18/396,672

(22) Filed: Dec. 26, 2023

(51) Int. Cl. B25B 7/20

(52) U.S. Cl. CPC B25B 7/20

(57) ABSTRACT

A cavity mold-replacing structure of a parallel crimping plier is provided. The structure includes a first crimping component having a first clamping handle and a crimping portion with a crimping opening; a second clamping handle having a first pivot member and a second clamping handle; a mold-pressing component including an upper mold-pressing member and a lower mold-pressing member; wherein the upper mold-pressing member is fixed at top of the crimping opening, and the lower mold-pressing member is pivot with the other end of the first pivot member and disposed below the crimping opening; and a mold-replacing component, having a mold-replacing block movably disposed in the internal space of the crimping portion and the mold-replacing block can be moved.

### FIELD OF THE DISCLOSURE

The present disclosure relates to a tool for crimping terminals and wires, and more particularly to a cavity mold-replacing structure of a parallel crimping plier.

### BACKGROUND OF THE DISCLOSURE

The crimping pliers mainly use the crimping module of the pliers to crimp the terminals and wires so that the wires are joined to the terminals. However, the terminals have different specifications based on different wires and are applied in different electrical appliances. Therefore, the crimping module of the crimping pliers must be replaceable to be used for different terminals.

Furthermore, most of the currently known crimping pliers are applied by pressing the clamping section and the handle section to move the two crimping parts in opposite directions, so that the pliers rotate to crimp the terminal. In this way, it easily leads to asymmetry on both sides of the terminal, and the terminal near the fulcrum will be deformed and crooked, which causes damage to the terminal and makes it impossible to use.

### SUMMARY OF THE DISCLOSURE

The present disclosure provides a cavity mold-replacing structure of a parallel crimping plier. By pressing with one hand, the user can quickly and easily replace the corresponding cavity mold component according to different terminals. Further, the terminals are crimped evenly in an upper and lower parallel manner to avoid asymmetry or deformation of the terminals and improve work efficiency.

In order to achieve the above-mentioned objective and effort, the present disclosure provides a cavity mold-replacing structure of a parallel crimping plier. The structure includes a first crimping component having a first clamping handle and a crimping portion with a crimping opening; a second clamping handle having a first pivot member and a second clamping handle; a mold-pressing component including an upper mold-pressing member and a lower mold-pressing member; wherein the upper mold-pressing member is fixed at top of the crimping opening, and the lower mold-pressing member is pivot with the other end of the first pivot member and disposed below the crimping opening; a cavity mold component, connected to the mold-pressing component; and a mold-replacing component, having a mold-replacing block movably disposed in the internal space of the crimping portion and abutted one end of the cavity mold component. By pressing the mold-replacing block, the mold-replacing block pushes the cavity mold component toward the crimping opening of the crimping portion, so that the cavity mold component can be replaced.

### BRIEF DESCRIPTION OF THE DRAWINGS

The described embodiments may be better understood by reference to the following description and the accompanying drawings in which:

FIG. 1 is an exploded perspective schematic view of the present disclosure;

FIG. 2 is an assembled perspective schematic view of the present disclosure;

FIG. 3 is a sectional schematic view of the present disclosure;

FIG. 4 is a sectional schematic view of line IV-IV of FIG. 3 of the present disclosure;

FIG. 5 is a sectional schematic view of the movement according to FIG. 4 of the present disclosure;

FIG. 6 is a sectional schematic view of the mold-pressing component of the present disclosure; and

FIG. 7 is a sectional schematic view of the cavity mold component of the present disclosure.

### DETAILED DESCRIPTION OF THE EXEMPLARY EMBODIMENTS

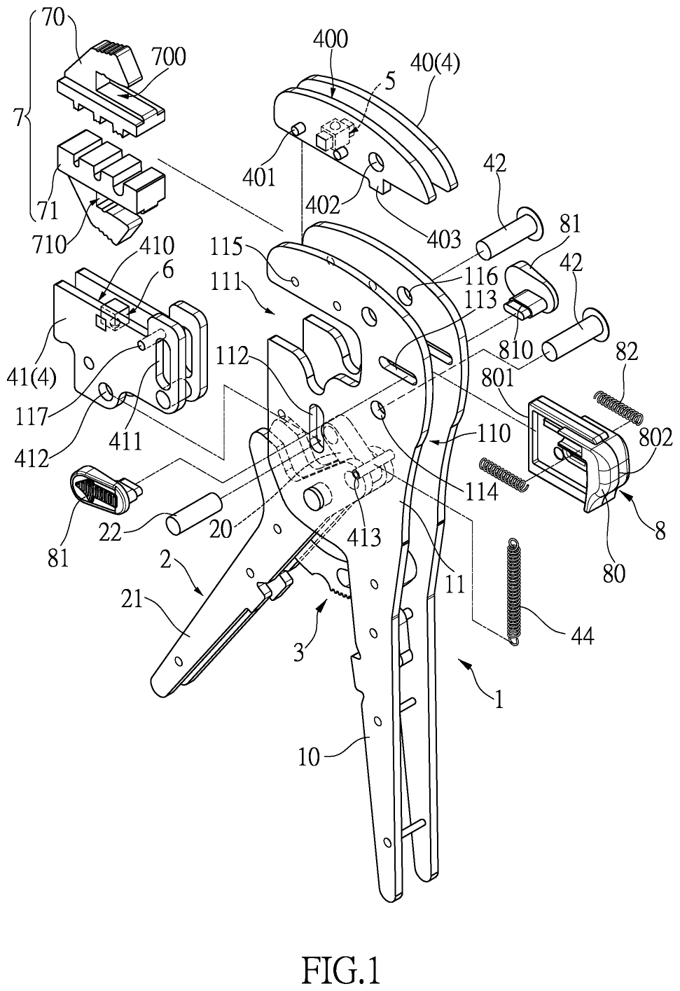

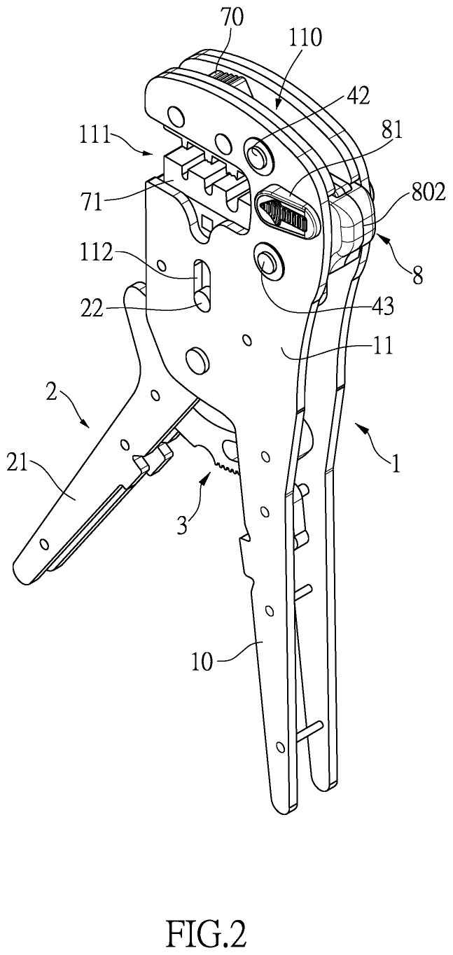

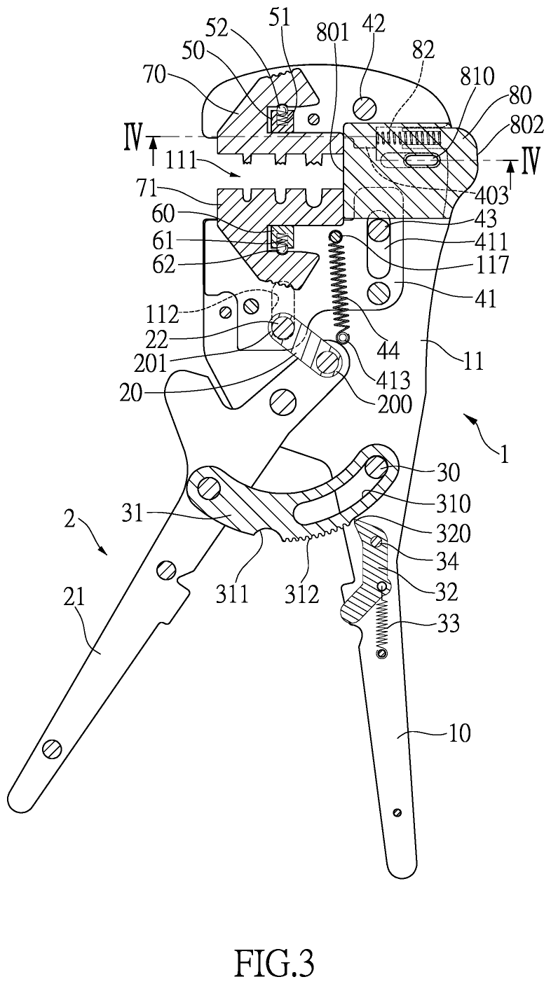

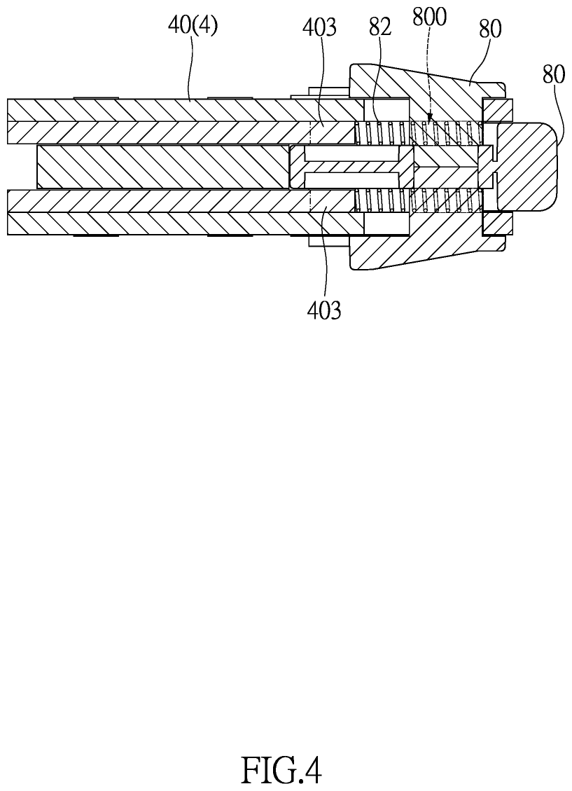

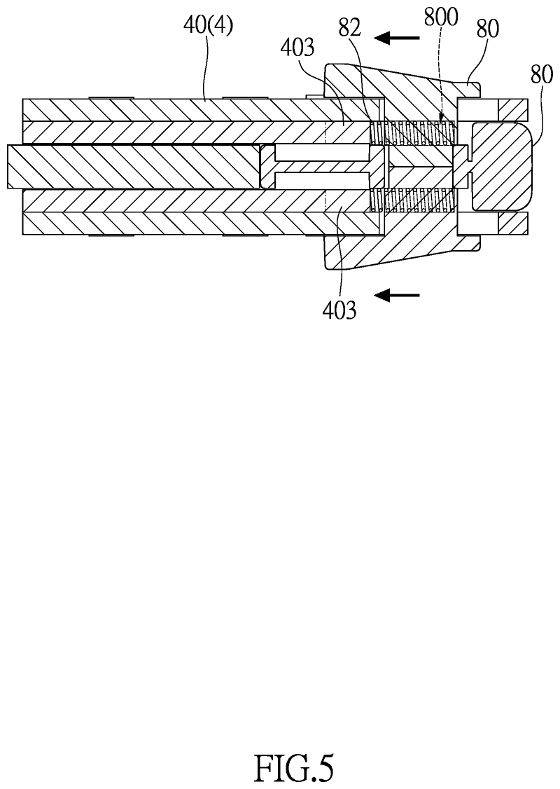

Referring to FIGS. 1-7, the present disclosure provides a cavity mold-replacing structure of a parallel crimping plier, which is used to crimp terminals and wires. The structure includes a first crimping component 1, a second crimping component 2, a transmission component 3, a mold-pressing component 4, an upper replacing component 5, a lower replacing component 6, a cavity mold component 7, and a mold-replacing component 8.

The first crimping component 1 has a first clamping handle 10 and a crimping portion 11 disposed on top of the first clamping handle 10. The crimping portion 11 has an internal space 110 and a crimping opening 111 communicated to the internal space 110, a first pressing hole 112, a sliding hole 113, a first limiting hole 114, a first fixing hole 115, a second fixing hole 116, and a first rod 117.

The second crimping component 2 has a first pivot member 20 and a second clamping handle 21. The first pivot member 20 has a first pivot end 200 and a second pivot end 201, and the second pivot end 201 is tightened on the first pressing hole 112 of the crimping portion 11 by a tightening member 22. The top end of the second clamping handle 21 is inserted into the internal space 110 and forms a pivoting connection with the crimping portion 11 and the first pivot end 200 of the first pivot member 20 respectively. Therefore, the first pivot end 200 of the first pivot member 20 and the second pivot end 201 pivots up and down as the second clamping handle 21 moves relative to the first clamping handle 10.

The transmission component 3 includes a guiding member 30, a detent piece 31, a detent member 32, and a reset member 33. The guiding member 30 is disposed on the first clamping handle 10 and adjacent to the crimping portion 11, the detent piece 31 has a guiding hole 310, a releasing groove 311, and a one-way ratchet 312, and one end of the detent piece 31 is fixedly connected to the second clamping handle 21 and the other end has the guiding hole 310 allowing the guiding member 30 to pass through. The detent member 32 is pivotally disposed on the first clamping handle 10 through a second pivot member 34 and has a detent portion 320 at one end of the detent member 32 that corresponds to the one-way ratchet 312. One end of the reset member 33 is fixed to the first clamping handle 10 and the other end is connected to the second pivot member 34.

Therefore, when the user presses the second clamping handle 21, the detent member 31 is driven to displace toward the first clamping handle 10, at the same time, the one-way ratchet 312 of the detent piece 31 and the detent portion 320 of the detent member 32 are interlinked and drive the two ends of the detent member 32 to pivot upward and downward. The reset member 33 provides the detent member 32 with a reset effect.

The mold-pressing component 4 is disposed in the internal space 110 of the crimping portion 11 and includes an upper mold-pressing member 40 and a lower mold-pressing member 41. The upper mold-pressing member 40 includes an upper receiving groove 400, a fixing portion 401, a third fixing hole 402, and a stopper 403. The fixing portion 401 is fixed at the first fixing hole 115 of the crimping portion 11. The third fixing hole 402 corresponds to the second fixing hole 116 of the crimping portion 11, and the third fixing hole 402 and the second fixing hole 116 are fixedly assembled by a fixing member 42, so that the upper mold-pressing member 40 is fixedly assembled on the top of the crimping opening 111. The lower mold-pressing member 41 includes a lower receiving groove 410, a second limiting hole 411, a second pressing hole 412, and a second rod 411. The second limiting hole 411 corresponds to the first limiting hole 114 of the crimping portion 11 and is fixedly assembled by a limiting member 43, the second pressing hole 412 corresponds to the first pressing hole 112 of the crimping portion 11 and is assembled by a tightening member 22. The second rod 413 and the first rod 117 are connected by a mold-pressing elastic member 44.

Therefore, the lower mold-pressing member 41 is movably disposed below the crimping opening 111 and moves up and down in parallel with the tightening member 22 in the first pressing hole 112, and the mold-pressing elastic member 44 moves along with the lower mold-pressing member 41 up and down in parallel to form compressed state or released state.

The upper replacing component 5 is disposed on the upper receiving groove 400 of the upper mold-pressing member 40 and has an upper fixed base 50, an upper elastic member 51, and an upper movable bead 52. The upper elastic member 51 is accommodated in the upper fixed base 50 and connected to the upper movable bead 52 by the top of the upper elastic member. The upper movable bead 52 forms upper and lower elastic expansion and contraction through the upper elastic member 51.

The lower replacing component 6 is disposed on the lower receiving groove 410 of the lower mold-pressing member 41 and has a lower fixed base 60, a lower elastic member 61, and a lower movable bead 62. The lower elastic member 61 is accommodated in the lower fixed base 60 and connected to the lower movable bead 62 by the top of the lower elastic member 61. The lower movable bead 62 forms up and down elastic expansion and contraction through the lower elastic member 61.

The cavity mold component 7 includes an upper cavity module 70 and a lower cavity module 71 corresponding to the upper cavity module 70. The upper cavity module 70 and the lower cavity module 71 include an upper engaging groove 700 and a lower engaging groove 710, respectively. The upper engaging groove 700 is engaged with the upper movable bead 52 of the upper replacing component 5, so that the upper cavity module 70 is connected to the upper mold-pressing member 40 and positioned above the crimping opening 111. The lower engaging groove 710 is engaged with the lower movable bead 62 of the lower replacing component 6, so that the lower cavity module 71 is connected to the lower mold-pressing member 41 and positioned below the crimping opening 111.

The mold-replacing component 8 includes a mold-replacing block 80, a sliding block 81, and two mold-replacing elastic members 82. The mold-replacing block 80 has two sliding grooves 800 on both sides, and a first mold-replacing block end 801 and a second mold-replacing block end 802 on both ends respectively. The sliding block 81 has a sliding protrusion 810, and the sliding protrusion 810 passes through the sliding holes 113 of the crimping portion 11 and abuts against the sliding grooves 800 of the mold-replacing block 80. The mold-replacing elastic members 82 are accommodated in the sliding grooves 800 of the mold-replacing block 80 respectively, and one end of each of the mold-replacing elastic members 82 abuts against the stopper 403 of the upper mold-pressing member 40.

Therefore, by the sliding block 81, the mold-replacing block 80 is limited at the internal space 110 of the crimping portion 11 and adjacent to the crimp opening 111, so that the first mold-replacing block end 801 of the mold-replacing block 80 abuts the ends of the upper cavity module 70 and the lower cavity module 71, and the second mold-replacing block end 802 is exposed outside the crimping portion 11. The mold-replacing elastic member 82 forms a compressed state or released state with the mold-replacing block 80 moving left and right.

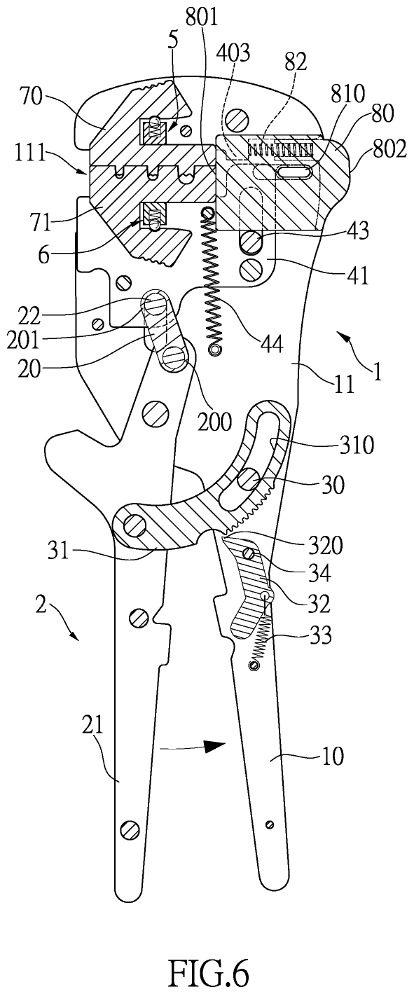

In practice, a terminal (not shown in the figures) is placed on the crimping opening 111, the user presses the second clamping handle 21 to move close to the first clamping handle 10, and the detent piece 31 is driven to move synchronously. At the same time, the one-way ratchet 312 of the detent piece 31 and the detent portion 320 of the detent member 32 form a one-way detent to prevent the detent piece 31 from being reset. Meanwhile, the mold-pressing elastic member 44 is in a compressed state, the first pivot end 200 of the first pivot member 20 moves downward, the second pivot end 201 moves upward and drives the tightening member 22 at the first pressing hole 112 of the lower mold-pressing member 41 moves upward. The lower mold-pressing member 41 drives the lower cavity module 71 to move upward and parallel synchronously (as shown in FIG. 6), so that the diameter of the crimping opening 111 is reduced and the terminals are crimped through the upper cavity module 70 and the lower cavity module 71. When the crimping is completed, the releasing groove 311 of the detent piece 31 just contacts the detent portion 320 of the detent member 32, so that the relationship between the detent piece 31 and the detent member 32 is released, and the detent piece 31 reverses the reset. At this time, the second clamping handle 21 is released. The mold-pressing elastic member 44 releases and pushes the lower mold-pressing member 41 to move downward in parallel, so that the diameter of the crimp opening 111 is increased, and the terminals can be removed. Therefore, by pressing the second clamping handle 21 to move the lower mold-pressing member 41 up and down in parallel, the two ends of the terminal can be evenly crimped, so that asymmetry or deformation of the terminal can be avoided.

It is worth mentioning that the one-way ratchet 312 of the detent piece 31 and the detent portion 320 of the detent member 32 are in a one-way gearing structure, the detent piece 31 can only move in the direction toward the first clamping handle 10 before the releasing groove 311 of the detent piece 31 contacts the detent portion 320 of the detent member 32. After crimping, the releasing groove 311 of the detent piece 31 is displaced to contact the detent portion 320 of the detent member 32. At this time, the relationship between the detent piece 31 and the detent member 32 is released, so that the detent piece 31 can reverse to reset. In other words, incomplete crimping operation can be avoided by the transmission assembly 3. When the lower mold-pressing member 41 moves in parallel up and down, it can be limited by the first limiting hole 114 through the limiting member 43, thus avoiding shaking and unbalance to the structure.

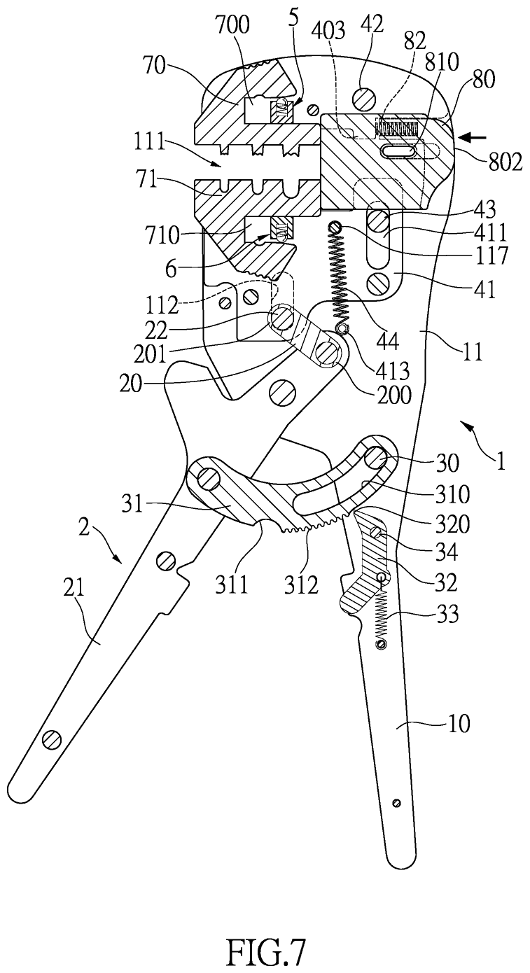

The replacement of the upper cavity module 70 and the lower cavity module 71 for crimping different terminals, can be found in FIG. 7. Press the first mold-replacing block end 801 of the mold-replacing block 80, and the second mold-replacing block end 802 of the mold-replacing block 80 simultaneously pushes the upper cavity module 70 and the lower cavity module 71 to move toward the crimping opening 111 of the crimping portion 11, so that the upper cavity module 70 and the lower cavity module 71 are partially moved to the outside of the crimping opening 111 and can be removed and replaced. Further, when the upper cavity module 70 and the lower cavity module 71 move toward the outside of the crimping opening 111, the upper engaging groove 700 and the lower engaging groove 710 quickly detach from the upper movable bead 52 and the lower movable bead 62 by the elastic release of the upper movable bead 51 and the lower movable bead 61. Therefore, the structure provides the effect of quickly replacing the cavity mold component 7.

What is claimed is:

1. A cavity mold-replacing structure of a parallel crimping plier, including:
a first crimping component, having a first clamping handle and a crimping portion disposed on top of the first clamping handle; wherein the crimping portion has an internal space and a crimping opening communicated to the internal space;
a second crimping component, having a second clamping handle and a first pivot member, one end of the second clamping handle is pivot with the internal space of the crimping portion and top of the second clamping handle is pivot with one end of the first pivot member;
a mold-pressing component, disposed in the internal space of the crimping portion and including an upper mold-pressing member and a lower mold-pressing member; wherein the upper mold-pressing member is fixed at top of the crimping opening, and the lower mold-pressing member is pivot with the other end of the first pivot member and movably disposed below the crimping opening; and
a mold-replacing component, having a mold-replacing block disposed in the internal space of the crimping portion, and the mold-replacing block can be moved.

2. The cavity mold-replacing structure of a parallel crimping plier according to claim 1, wherein the crimping portion further includes a sliding hole connected to the internal space, and the mold-replacing component includes a sliding block, a sliding protrusion and a slip groove; wherein the sliding grooves are disposed on both sides of the mold-replacing block and faces the sliding protrusion of the sliding block, and the sliding protrusion of the sliding block passes through the sliding hole and abuts against the sliding grooves.

3. The cavity mold-replacing structure of a parallel crimping plier according to claim 2, wherein the upper mold-pressing member includes a stopper, and the mold-replacing component includes two mold-replacing elastic members accommodated in the sliding grooves of the mold-replacing block; wherein one end of each of the mold-replacing elastic member abuts against the stopper of the upper mold-pressing member.

4. The cavity mold-replacing structure of a parallel crimping plier according to claim 1, further including a cavity mold component connected with the mold-pressing component and part of the cavity mold component being exposed to the crimping opening of the crimping portion; wherein the cavity mold component includes has an upper cavity module and a lower cavity module corresponding to the upper cavity module, and the upper cavity module and the lower cavity module are respectively disposed above and below the crimping opening; wherein the mold-replacing block has a first mold-replacing block end and a second mold-replacing block end on both ends respectively, the first mold-replacing block end abuts the ends of the upper cavity module and the lower cavity module, and the second mold-replacing block end is exposed outside the crimping portion.

5. The cavity mold-replacing structure of a parallel crimping plier according to claim 4, further including a upper replacing component and lower replacing component; wherein the upper replacing component includes an upper fixed base, an upper elastic member and an upper movable bead, and the upper elastic member is accommodated in the upper fixed base and connected to the upper movable bead by top of the upper elastic member; wherein the lower replacing component includes a lower fixed base, a lower elastic member and a lower movable bead, and the lower elastic member is accommodated in the lower fixed base and connected to the lower movable bead by top of the lower elastic member; wherein the upper mold-pressing member includes an upper receiving groove for accommodating the upper replacing component and the lower mold-pressing member includes a lower receiving groove for accommodating the lower replacing component; wherein the upper cavity module includes a upper engaging groove engaged with the upper movable bead, and the lower cavity module includes a lower engaging groove engaged with the lower movable bead.

6. The cavity mold-replacing structure of a parallel crimping plier according to claim 1, wherein the crimping portion has a first pressing hole communicated with the internal space, and the first pivot member has a first pivot end and a second pivot end; wherein the lower mold-pressing member has a second pressing hole corresponding to the first pressing hole, the first pivot end of the pivot member is pivotally connected to top of the second clamping handle, and the second pivot end and the second pressing hole are jointly tightened on the first pressing hole by a tightening member.

7. The cavity mold-replacing structure of a parallel crimping plier according to claim 1, wherein the crimping portion further includes a first fixing hole and a second fixing hole connected to the internal space, the upper mold-pressing member includes a fixing portion and a third fixing hole; wherein the fixing portion is fixed on the first fixing hole, and the third fixing hole corresponds to the second fixing hole and fixedly assembled by a fixing member.

8. The cavity mold-replacing structure of a parallel crimping plier according to claim 1, wherein the crimping portion further includes a first limiting hole connected with the internal space, the lower mold-pressing member includes a second limiting hole, and the first limiting hole and the second limiting hole correspond to each other and fixedly assembled by a limiting member.

9. The cavity mold-replacing structure of a parallel crimping plier according to claim 1, wherein the crimping portion further includes a first rod communicated with the internal space, and the lower mold-pressing member includes a second rod; wherein the first rod and the second rod are connected by a mold-pressing elastic member.

10. The cavity mold-replacing structure of a parallel crimping plier according to claim 1, further including transmission component; wherein the transmission component includes a guiding member, a detent piece, a detent member, and a reset member; wherein the guiding member is disposed on the first clamping handle and adjacent to the crimping portion, the detent piece has a guiding hole, a releasing groove and a one-way ratchet, and one end of the detent piece is fixedly connected to the second clamping handle and the other end has the guiding hole allowing the guiding member to pass through; wherein the detent member is pivotally disposed on the first clamping handle and has a detent portion at one end of the detent member corresponding to the one-way ratchet; wherein one end of the reset member is fixed to the first clamping handle.
